(19) United States
(12) Patent Application Publication
(10) Pub. No.: US 2006/0116132 A1
(43) Pub. Date: Jun. 1, 2006

(54) Method and a system for managing a fleet of vehicles, and an associated vehicle

(75) Inventor: Jacques Le Gars, Gambais (FR)

Correspondence Address: MILLER, MATTHIS & HULL, ONE NORTH FRANKLIN STREET, SUITE 2350, CHICAGO, IL, 60606, US

(73) Assignee: JCDecaux SA, Neuilly Sur Seine (FR)

(21) Appl. No.: 11/274,745

(22) Filed: Nov. 15, 2005

(30) Foreign Application Priority Data
Nov. 22, 2004 (FR) FR 04 12374

(51) Int. Cl. H04Q 7/20

(52) U.S. Cl. 455/456.1

(57) ABSTRACT

The invention provides a system for managing a fleet of vehicles suitable for being returned to at least one station having locations for vehicles, the station being declared to be available when at least one of its locations is not occupied by a vehicle, and to be unavailable when each of the locations of the station is occupied by a vehicle, the system comprising: means for evaluating the availability of the station; means for remote communication with a vehicle that has not been returned; and means for displaying on the vehicle information about availability.

The invention deals with managing fleets of vehicles for collective use, and in particular, but not only, to managing a fleet of bicycles made available for rent.

### BACKGROUND OF THE INVENTION

Nowadays, certain cities are fitted with automatic systems for renting bicycles that enable each city dweller to hire a bicycle to make a trip in town.

Such systems comprise one or more stations, each provided with locations where bicycles can be stored, and in practice each location is physically in the form of a post or bollard to which a bicycle can be attached. The bollards are connected to a controller provided with a user interface enabling a user to cause a bollard to unlock a bicycle in return for communicating specific information, such as bank details or a predetermined user code, thus enabling the user to make use of the corresponding bicycle.

A procedure for renting a bicycle, a bollard, and locking means therefor are described in detail in the international patent applications published under the numbers WO 02/095698 and WO 01/54080 in the name of the Applicant, to which the person skilled in the art can refer.

Once the bicycle is available to the user, the user can go freely to a chosen destination. Nevertheless, the user must bear in mind that when the rental comes to end the user will be called upon to return the bicycle to a station. It will be understood that for this purpose said station must have at least one empty location (the station is then said to be “available”). Otherwise, the station is “unavailable” and the user must look for a station that is available. Given the time that can be lost in this way, the user might become liable for penalties for lateness.

Proposals have been made (cf. the international patent application published under the No. WO 98/09254) to set up a procedure whereby, on renting the bicycle, the user informs a control system of the intended destination, and the system then reserves in advance an available location close to said destination.

However, that system solves the above-mentioned problems in part only, since it does not enable the user to change destination on the way. Furthermore, it does not solve the question of no locations being available in the vicinity of the destination chosen by the user. Also, given the sometimes lengthy duration of bicycle rentals, it can result from that procedure that numerous vacant places that could be allocated as a function of immediate needs, are in fact pointlessly monopolized waiting for the arrival of the corresponding bicycle. This ends up by managing the fleet in a manner that is not optimized.

### OBJECTS AND SUMMARY OF THE INVENTION

The invention seeks to remedy the above-mentioned drawbacks by proposing a method of managing a fleet of vehicles, such as bicycles, that optimizes the use of locations where vehicles are returned, and that can simultaneously satisfy the ease-of-use requirements expressed by users.

To this end, the invention firstly provides a method of managing a fleet of vehicles suitable for being returned to a station having locations for vehicles, the station being declared to be available so long as at least one of its locations is not occupied by a vehicle, and to be unavailable when each of its locations is occupied by a vehicle, the method comprising the steps consisting in:

detecting that a vehicle has been hired;

evaluating the availability of the station; and

transmitting to the hired vehicle, via remote communications means, information about the availability of the station.

As a result, the user of a bicycle can be informed about the availability (or on the contrary the lack of availability) of a given station. By being warned in advance in this way, in the event of the station being available, the user is certain to be able to return the bicycle.

The invention secondly provides a method of managing a fleet of vehicles suitable for being returned to a plurality of stations, each having locations for vehicles, each station being declared to be available so long as at least one of its locations is not occupied by a vehicle, and to be unavailable when each of the locations in the station is occupied by a vehicle, the method comprising the steps consisting in:

detecting that a vehicle has been hired;

evaluating the availability of each station;

determining the station(s) that is/are closest to the vehicle; and

transmitting to the hired vehicle, via remote communications means, information about the availability of the nearest station(s).

Thus, the user is informed about the availability of the stations that are nearest. The user can therefore select in advance from amongst the available stations the station which will suit the user best, and the user will be certain of being able to return the bicycle at that station.

The invention thirdly provides a method of managing a fleet of vehicles suitable for being returned to a plurality of stations, each having locations for vehicles, each station being declared to be available so long as at least one of its locations is not occupied by a vehicle, and to be unavailable when each of the locations of the station is occupied by a vehicle, the method comprising the steps consisting in:

detecting that a vehicle has been hired;

locating a destination station of the vehicle;

evaluating the availability of the destination station; and

transmitting to the hired vehicle, via remote communications means, information about the availability of the destination station.

The user is thus informed about the availability of the user's destination station. If available, then the user is certain to be able to return the bicycle. Otherwise, the user can decide to do something different, e.g. wait until later.

In an embodiment, information is transmitted to the vehicle via a stationary communications relay.

Furthermore, the availability of the station(s) may be evaluated on a continuous basis, as may the transmission of information to the vehicle.

The method may include a step consisting in displaying availability information on a user interface fitted to the vehicle, and a step consisting in detecting that the vehicle is stationary, with the availability information being displayed only when it has been detected that the vehicle is stationary.

The invention also provides a system for managing a fleet of vehicles suitable for being returned to at least one station having locations for vehicles, the station being declared to be available when at least one of its locations is not occupied by a vehicle, and to be unavailable when each of the locations of the station is occupied by a vehicle, the system comprising:

means for evaluating the availability of the station;

means for remote communication with a vehicle that has not been returned; and

means for displaying on the vehicle information about availability.

This system enables the above-specified methods to be implemented.

### BRIEF DESCRIPTION OF THE DRAWINGS

Other objects and advantages of the invention appear in the light of the following description made with reference to the accompanying drawings, in which:

FIG. 1 is a perspective diagram showing a system for managing a fleet of bicycles;

FIG. 2 is a block diagram showing the internal organization of the FIG. 1 system; and

FIGS. 3 to 5 are flow charts showing a method of managing a vehicle fleet in accordance with the invention, in three distinct implementations.

### MORE DETAILED DESCRIPTION

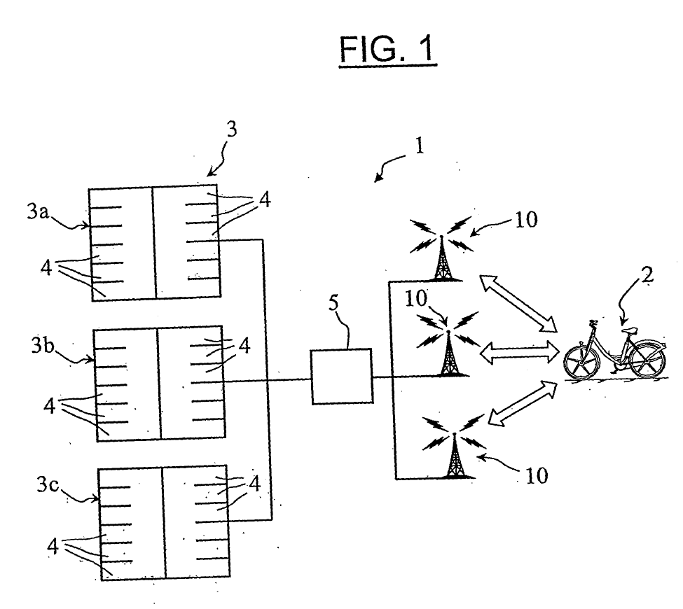

FIG. 1 shows a system 1 for managing a fleet of bicycles 2 made available for rent, in particular in a city.

The fleet comprises at least one station 3 (it may comprise a plurality of stations, as shown in FIG. 1, where there are three stations 3a, 3b, and 3c), each provided with a plurality of locations 4 where a bicycle 2 can be returned.

Although the locations 4 are shown diagrammatically as side-by-side slots, in practice they are implemented by bollards (not shown), each provided with a locking system to which a bicycle 2 can be releasably secured (release on authorization).

The station 3 is said to be available when at least one of its locations 4 is not occupied by a bicycle, and, on the contrary, it is said to be unavailable when each of its locations 4 is occupied by a respective bicycle.

As shown in FIG. 1, the stations 3a, 3b, and 3c are connected to a control center 5 which continuously evaluates availability. In practice, each bollard is connected to the center 5 which monitors the state of the bollard's locking system: when the system is active, indicating that a bicycle is attached to the bollard, the corresponding location 4 is considered as being occupied; in contrast when the system is inactive (which means that no bicycle is secured to the bollard), the location 4 is considered as being unoccupied.

Each bicycle 2 is fitted with:

a central control unit (CPU) 6;

a transceiver 7 connected to the CPU 6;

a user interface 8 also connected to the CPU 6, including a display screen, e.g. a liquid crystal type screen, placed in a case supported by the handlebar and visible through a transparent window; and

a system 9 for measuring the speed of the bicycle, which system is also connected to the CPU 6.

In practice, the system 9 may be formed by a dynamo fitted of one of the wheels of the bicycle 2 and delivering the CPU 6 with electricity proportional to the speed of rotation of the wheel. In particular, it is possible to detect that the bicycle 2 is stationary by the CPU 6 detecting that no electricity is coming from the dynamo. In a possible alternative, one of the wheels of the bicycle 2 may be fitted with a bearing, itself fitted in such a manner as to deliver a signal to the CPU 6 in proportion to the speed of rotation of the wheel.

As can be seen in FIG. 1, the system 1 includes a plurality of telecommunications relays 10, connected to the control center 5 and suitable for remotely communicating with the CPU 6 of the bicycle 2 via its transceiver 7.

By way of example, the relays 10 and the transceiver 7 are organized to transmit and receive radio signals in application of the industrial, scientific, and medical (ISM) protocol—operating in the 2.4 gigahertz (GHz) band.

In a city, the relays 10 may be disposed on street furniture, or they may be directly integrated therein, i.e. in billboards for advertising or information, in bus shelters, in traffic lights, or in lamp posts. By way of example, the relays 10 may be powered by batteries connected to the public lighting system, so as to be recharged at night while the lights are on. In order to increase the range of the relays 10 and to optimize operation of the system 1, it is preferable to place the relays 10 in busy areas, e.g. close to major cross-roads or traffic circles.

Furthermore, to avoid consuming too much energy, but without harming the operation of the system 1, the transmission power of the relays 10 may be adjusted in such a manner that their range is a few tens of meters, which, given the way the relays 10 are disposed at suitably selected points by the road side, enables information to be transmitted reliably to the bicycles 2 traveling in normal manner on public roads.

The power of the bicycle transceiver 7 can be adjusted so that its range, when in use, is several tens of meters, whereas on approaching the destination bollard and all the time the bicycle is connected thereto, the power of the transceiver 7 can be reduced to a range of less than one meter so as to allow it to communicate only with the bollard to which it is connected, and without interfering with a neighboring bollard.

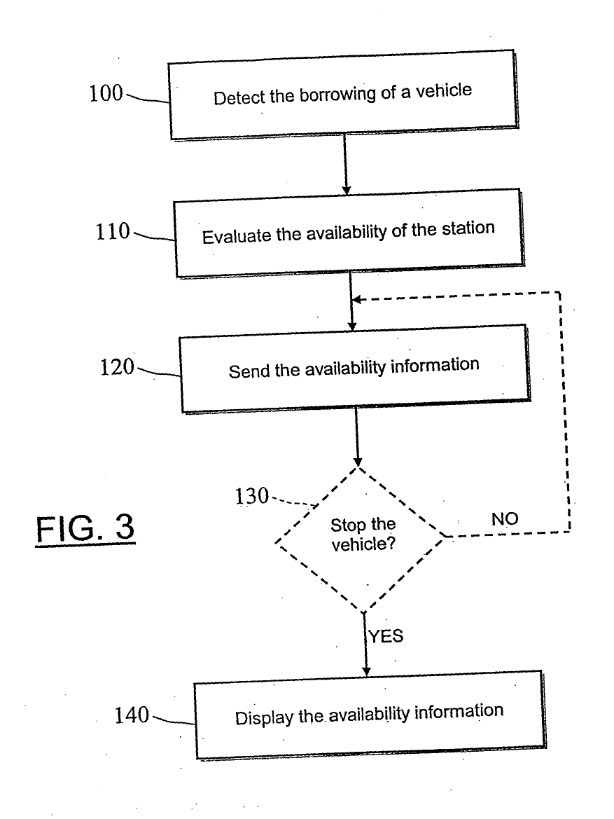

The above-described architecture makes it possible, as described below, to manage the fleet with increased effectiveness. In the description below, three methods of managing the fleet are described with reference to FIGS. 3, 4, and 5, respectively.

A first method of managing the fleet is described with reference to FIG. 3. This method, which corresponds to an implementation in which all of the fleet is for being returned to a single station 3, comprises an initial step (100) of detecting that a bicycle 2 has been hired. Specifically, this step consists in detecting the unlocking of the corresponding bollard.

The following step (110) consists in evaluating the availability of the station 3. This step is presented as following the detection step (100) since hiring a bicycle changes the availability of the station 3. However, in practice, the availability of the station 3 is evaluated on a continuous basis.

Thereafter (120), information concerning the availability of the station 3 is transmitted to the CPU 6 of the bicycle 2 via the relays 10 and the transceiver 7, and the availability information is displayed (140) on the user interface screen 8.

In order to avoid distracting the cyclist's attention by displaying the information even when the bicycle is moving, which increases the risk of an accident, provision is made, as represented by dashed lines in FIG. 3, to interpose, between the transmission step (120) and the display step (140), a step (130) of detecting that the bicycle is stationary, with display then being subordinated to detecting that the bicycle is stationary (e.g. when the bicycle has stopped at a traffic light).

The above-described method corresponds to managing a fleet of vehicles that are all to be returned to a single station. Ideally, the number of bicycles corresponds exactly to the number of available locations, such that it might be assumed that the station is permanently available for any hired vehicle. However reality can be different: in order to compensate for the risk of accidents or breakdowns affecting the bicycles, it can happen that the number of bicycles made available by the organization renting them out is in fact greater than the number of locations. In addition, it can also happen that one or more bollards are out of service, in which case the cyclist on being informed that the station is unavailable could be invited to go directly to a special place for collecting surplus bicycles.

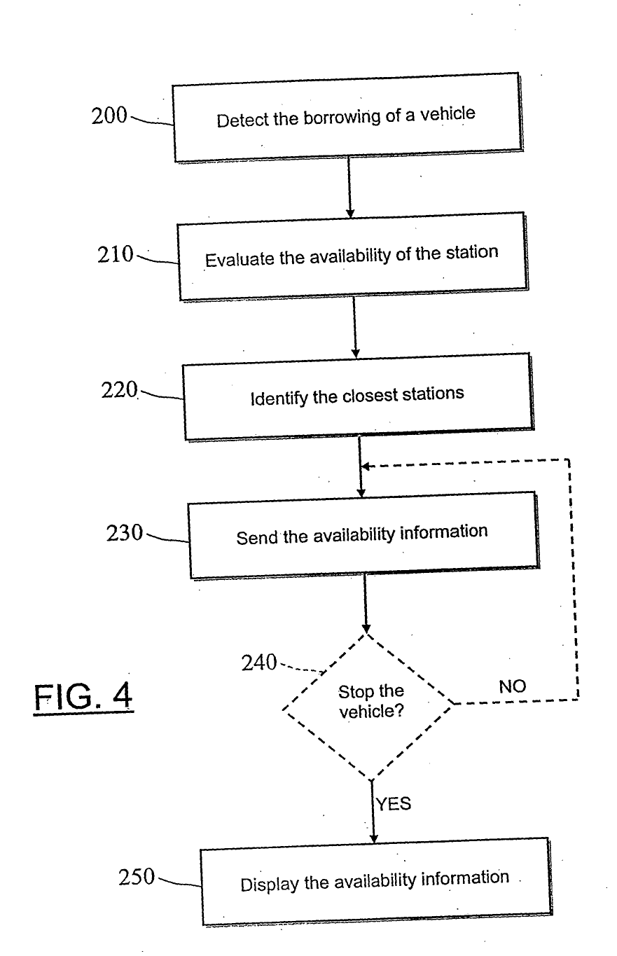

A second management method is described with reference to FIG. 4. This method, which corresponds to an implementation in which a plurality of stations 3a, 3b, and 3c are provided for receiving the fleet of bicycles, comprises, as above, a step (200) of detecting that a bicycle has been hired.

The following step (210) consists in evaluating the availabilities of the stations 3a, 3b, and 3c. As before, this step (210) is presented as following the detection step (200), since hiring the vehicle changes the general availabilities of the stations 3a, 3b, and 3c. However in practice, station availability is evaluated on a continuous basis.

Thereafter (220), it is determined which station(s) is/are closest to the present position of the vehicle, where said position is known by identifying the relay(s) dialoguing with the CPU of the bicycle.

Thereafter (230), information concerning the availability of the nearest station(s) is transmitted to the CPU 6 of the bicycle 2 via the relays 10 and the transceiver 7.

The availability information is then displayed (250) on the user interface screen 8. This display may be performed continuously, or as envisaged above, it may be subordinate to the bicycle being stationary, with a step (240) of detecting that the bicycle is stationary then being interposed between the transmission step (230) and the display step (250).

The cyclist is thus informed about the availability of the neighboring station(s), thus making it possible, either for the cyclist to be certain of being able to return the bicycle, or else for cyclist to head in anticipation to another station.

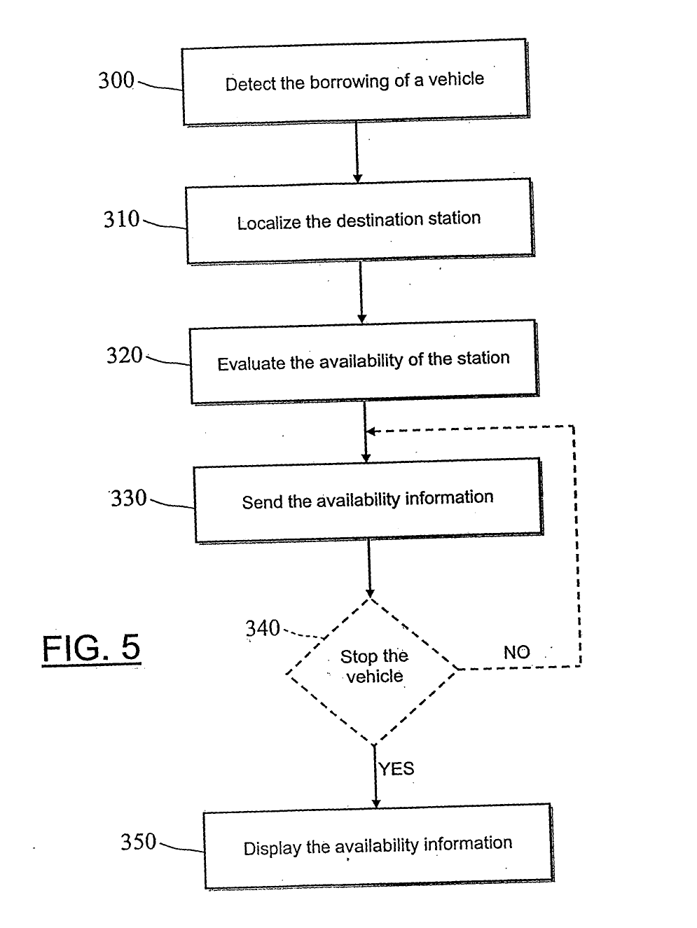

A third management method is described with reference to FIG. 5. This method, which corresponds to an embodiment in which a plurality of stations 3a, 3b, and 3c are likewise provided for receiving the fleet of bicycles, comprises, as above, a first step (300) of detecting that a bicycle has been hired.

The following step (310) consists in locating the destination station intended by the user. In practice, this step is performed by the user selecting a station from a list of stations proposed by a controller, thereby informing the controller where the user seeks to return the bicycle. It is also possible to envisage allowing the user to identify a geographical area to which the user seeks to go, with the controller then informing the user about the station(s) nearest to said zone, or included in said zone.

Thereafter (320) the availability of the destination station is evaluated. As described above, this step (320) is shown as following the detection step since hiring the vehicle changes the general availability of the station, however in practice the availability of the destination station (and possibly also the other stations) is evaluated continuously.

Thereafter, the information about the availability of the destination station is sent (330) to the CPU 6 of the bicycle 2 by the relays 10 and via the transceiver 7, or else, if the destination station turns out to be unavailable, information is sent about other stations that are closest to the present position of the bicycle, with the position of the bicycle being known by identifying which relay(s) 10 is/are in dialog with the CPU 6 of the bicycle 2.

Thereafter (350) the information about the availability of the destination station is displayed on the screen of the user interface 8. This display may be operated continuously, or as mentioned above, it may be subordinated to the bicycle being stationary, with a step (340) of detecting that the bicycle is stationary then being interposed between the transmission step and the display step.

Thus, whatever the implementation used, the cyclist is informed in good time of the availability of the station or stations where the cyclist would like to or is able to return the bicycle after it has been used. This enables the user to optimize use of the hired bicycle without it being necessary to leave a safety margin in the time available for use to cover the possibility of the intended bicycle return station being unavailable. This improves the ease of use of the rental system.

Furthermore, the system 1 and the methods as described above also enable the occupancy of the stations 3a, 3b, and 3c to be optimized since their free locations 4 can be allocated as a function of user requirements, and when a station is unavailable users are automatically diverted to the nearest station that is available.

Furthermore, it is possible to envisage managing the occupancy of the stations in predictive manner, by avoiding in anticipation any overloading of a station close to which the number of bicycles is greater than the number of free locations, and by diverting excess bicycles towards the available stations that are nearest, even before all of the free places have been occupied.

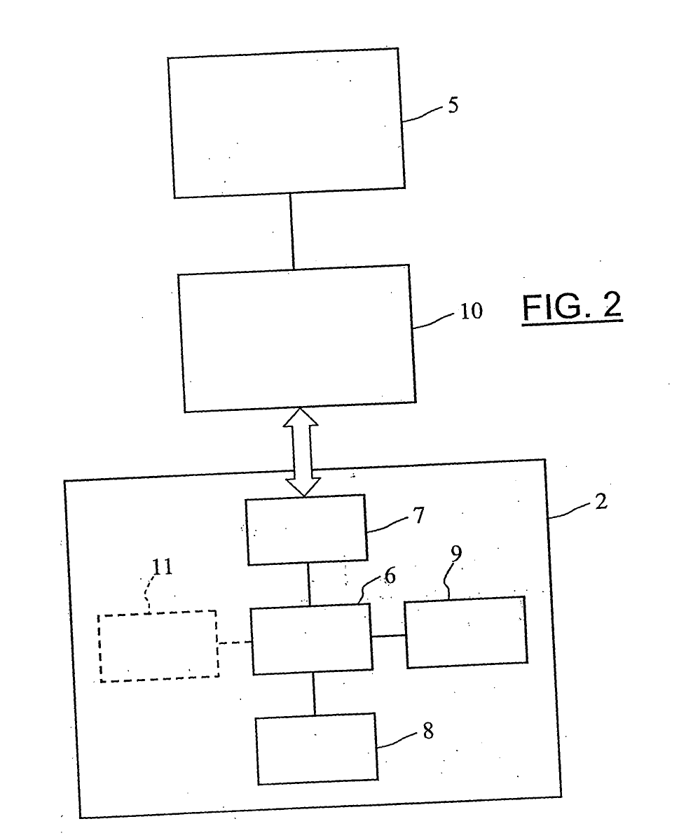

Furthermore, it is possible to guide bicycles towards these stations by fitting each bicycle with a compass 1 (in dashed lines in FIG. 2) connected to the CPU 6. Information about the direction in which the bicycle is heading, as provided by the compass 11, e.g. a gyrocompass, and as communicated to the central control unit 5 by the transceiver 7 and the relays 10 in dialog with the CPU 6 is associated with the information concerning the position of the bicycle 2 in order to return information to the user about the direction in which the nearest available station is to be found.

It is possible to envisage not only communicating information about the availability of stations, but also to evaluate the path followed by the bicycle by means of the dialog that is established between the bicycle and the successive relays that it encounters as it travels. This makes it possible, without having recourse to expensive satellite positioning systems (GPS), to determine the itinerary of the bicycle (which can be useful particularly when the use of the bicycle is dishonest), and also to predict its time of arrival at a station (thus making it possible by calculation to predict the occupancy of the station, and when calculation predicts that the station is becoming saturated, to divert the bicycles that are furthest away towards other stations that are still available).

Finally, although the display of availability information on the screen of the bicycle 2 is intended to be performed automatically in the implementation described above, it is possible to envisage subordinating such display to user taking positive action, such as pressing on a control button of the user interface 8.

Although the system and the method described above relate to managing a fleet of bicycles, it will be understood that they can be applied to any type of vehicle.

What is claimed is:

1. A method of managing a fleet of vehicles suitable for being returned to a station having locations for vehicles, the station being declared to be available so long as at least one of its locations is not occupied by a vehicle, and to be unavailable when each of its locations is occupied by a vehicle, the method comprising the steps consisting in:
detecting that a vehicle has been hired;
evaluating the availability of the station; and
transmitting to the hired vehicle, via remote communications means, information about the availability of the station.

2. A method of managing a fleet of vehicles suitable for being returned to a plurality of stations, each having locations for vehicles, each station being declared to be available so long as at least one of its locations is not occupied by a vehicle, and to be unavailable when each of the locations in the station is occupied by a vehicle, the method comprising the steps consisting in:
detecting that a vehicle has been hired;
evaluating the availability of each station;
determining the station(s) that is/are closest to the vehicle; and
transmitting to the hired vehicle, via remote communications means, information about the availability of the nearest station(s).

3. A method of managing a fleet of vehicles suitable for being returned to a plurality of stations, each having locations for vehicles, each station being declared to be available so long as at least one of its locations is not occupied by a vehicle, and to be unavailable when each of the locations of the station is occupied by a vehicle, the method comprising the steps consisting in:
detecting that a vehicle has been hired;
locating a destination station of the vehicle;
evaluating the availability of the destination station; and
transmitting to the hired vehicle, via remote communications means, information about the availability of the destination station.

4. A method according to claim 1, in which information is transmitted to the vehicle via a stationary communications relay.

5. A method according to claim 1, in which the availability of the station(s) is/are evaluated on a continuous basis.

6. A method according to claim 1, in which information is transmitted to the vehicle on a continuous basis.

7. A method according to claim 1, including a step consisting in displaying the availability information on a user interface fitted to the vehicle.

8. A method according to claim 7, including a step consisting in detecting that the vehicle is stationary with availability information being displayed only when it is detected that the vehicle is stationary.

9. A system for managing a fleet of vehicles suitable for being returned to at least one station having locations for vehicles, the station being declared to be available when at least one of its locations is not occupied by a vehicle, and to be unavailable when each of the locations of the station is occupied by a vehicle, the system comprising:
means for evaluating the availability of the station;
means for remote communication with a vehicle that has not been returned; and
means for displaying on the vehicle information about availability.
